(19) United States
(12) Patent Application Publication
(10) Pub. No.: US 2026/0326897 A1
(43) Pub. Date: Oct. 22, 2026

(54) HIGH LIFT APPARATUS FOR PROPELLER DRIVEN AIRCRAFT

(71) Applicant: Lester John Erlston, Beaverton, OR (US)

(72) Inventor: Lester John Erlston, Beaverton, OR (US)

(21) Appl. No.: 19/467,642

(22) Filed: Feb. 2, 2026

Related U.S. Application Data
(60) Provisional application No. 63/834,104, filed on Feb. 20, 2025.

(51) Int. Cl. B64C 29/00; B64C 9/32; B64D 27/31; B64D 27/34; B64D 27/40; B64D 29/02

(52) U.S. Cl. CPC B64C 29/0033; B64C 9/323; B64D 27/31; B64D 27/34; B64D 27/402; B64D 29/02

(57) ABSTRACT

An aerodynamic system for lift augmentation and thrust recovery in propeller-driven aircraft. The system includes at least one auxiliary wing positioned within a slipstream of a propeller and coupled to a propulsion assembly via at least one structural pylon. The auxiliary wing is configured to generate supplemental lift from the high-velocity airflow of the slipstream, particularly during high-thrust operational phases. The structural pylon is configured as a flow-rectifying vane to deswirl a rotational component of the slipstream, thereby increasing net axial thrust. The system facilitates energy conservation and accelerates the transition between vertical and horizontal flight modes by utilizing recovered slipstream energy to augment fixed-wing lift generation.

### CROSS-REFERENCE TO RELATED APPLICATIONS

THIS APPLICATION CLAIMS THE BENEFIT OF U.S. PROVISIONAL PATENT APPLICATION NO. 63/834,104, FILED Feb. 20, 2025, WHICH IS INCORPORATED BY REFERENCE HEREIN IN ITS ENTIRETY.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records but otherwise reserves all copyright rights whatsoever.

### FIELD

The present disclosure relates, in general, to aircraft, and more particularly to horizontal flight-lift technology that augments the efficiency of all aircraft, but more specifically to Short Takeoff and Landing aircraft (STOL) and tiltrotor-driven Vertical Takeoff and Landing aircraft (VTOL).

### BACKGROUND

Airplane motors push a slipstream of air from the front of the plane towards the rear to impart forward motion to the plane. Lift is generated through aerodynamic pressure differentials and flow deflection. Thus, the air rushing over the shaped fixed wing develops a higher pressure on the bottom side of the wing than on the longer contoured top side, providing lift to the plane's wings. Regardless of whether the wing is behind or in front of the slipstream core, the differences in the air velocity between the top and bottom of the fixed wing causes the airplane to rise vertically. However, regardless of the motor placement, the slipstream imparts a thrust component (vector) to keep the plane moving forward.

However, a substantial proportion of the slipstream core, which is kinetic energy created from the thrust generated by the propeller to propel the aircraft forward, is “wasted” because only the central horizontal portion of the slipstream core, roughly about a third of the available slipstream core energy, interacts with the fixed-wing to generate lift in airplane where the wing resides in the slipstream core.

Further, since the propeller imparts a circular spiraling motion to the slipstream core, much of the thrust of the plane's motor is lost with respect to providing lift or forward motion because it is non-linear with respect to the longitudinal axis of the plane's body and the control surfaces of the fixed wing.

Henceforth, a higher efficiency design that recovers the lost slipstream core energy and that can deswirling some of the spiral motion of the slipstream core and turn it into a useful thrust, providing more lift and greater vertical air speed, would fulfill a long-felt need in the aviation industry. This invention utilizes and combines known and new technologies in a unique and novel configuration to overcome the aforementioned problems and accomplish this. The result is a substantially increased flight range, payload capacity and fuel efficiency while reducing operational costs, by using previously wasted energy to supplement the aircraft's propulsion system.

### BRIEF SUMMARY

In accordance with various embodiments, a system of additional auxiliary wings braced by structural struts (pylons) to the propulsion assembly is provided that can increase lift and forward thrust from the motor.

In one aspect, a wing design that provides a dual-action recovery of lost energy, by extracting lift from both the velocity and the swirl of the slipstream produced behind the propeller.

In another aspect, an auxiliary wing design for a VTOL aircraft that can minimize the time spent in transitioning from a rotor-driven helicopter-type vertical takeoff to a fixed-wing horizontal flight by utilizing the slipstream core generated horizontal lift as the propulsion assembly tilts or rotates to accelerate the transition to cruising speed.

In another aspect, an auxiliary wing design for a tiltrotor or VTOL aircraft that acts an air brake, reducing the drag to slow the aircraft quicker when transitioning to a hover mode.

In yet another aspect, at least one auxiliary wing anchored to the propulsion assembly by pylons adapted for deswirling the air in the slipstream core to minimize drag, propeller wash, wake and turbulence.

In yet another aspect, a design that augments horizontal flight lift through maximized utilization of propeller slipstream kinetic energy via additional auxiliary wings to gain additional “free” lift from a portion of the previously unused slipstream core, and that gains horizontal thrust through pylons configured to deswirl the spiraling slipstream core airflow.

Various modifications and additions can be made to the embodiments discussed without departing from the scope of the invention.

### BRIEF DESCRIPTION OF THE DRAWINGS

A further understanding of the nature and advantages of particular embodiments may be realized by reference to the remaining portions of the specification and the drawings, in which like reference numerals are used to refer to similar components.

FIG. 1 is a top perspective view of a pair of auxiliary wings on a fixed-wing VTOL aircraft in horizontal flight mode, where the auxiliary wings are affixed to the propulsion assembly by pylons;

FIG. 2 is a top perspective view of a pair of auxiliary wings on the fixed-wing VTOL aircraft of FIG. 1 but in vertical lift mode;

FIG. 3a is a top view of the fixed-wing VTOL aircraft of FIG. 1 in horizontal flight mode;

FIG. 3b is a top view of the fixed-wing VTOL aircraft of FIG. 2 in horizontal flight mode;

FIG. 4a is a side of the fixed-wing assembly of the VTOL aircraft of FIG. 1 in the horizontal flight configuration;

FIG. 4b is a side view of the fixed-wing assembly of the VTOL aircraft of FIG. 2 in the vertical flight configuration;

FIG. 5a is a front view of the left wing of a twin engine monoplane;

FIG. 5b is a front view of the left wing of a twin engine monoplane with an upper and lower auxiliary wing mounted with pylons to the propulsion assembly;

FIG. 6a is a side view of the right wing of a twin engine monoplane;

FIG. 6b is a side view of the right wing of a twin engine monoplane with an upper and lower auxiliary wing mounted with pylons to the propulsion assembly;

FIG. 7 is a representative view illustrating the spiraling slipstream core airflow that passes between the upper and lower auxiliary wings;

FIG. 8a is a representative view of the slipstream core airflow behind the propeller interacting with a fixed wing;

FIG. 8b is a representative view of the slipstream core airflow behind the propeller interacting with a fixed-wing and an upper and lower auxiliary wing;

FIG. 9 is a side view of an alternate embodiment auxiliary arced upper and lower auxiliary wing; and

FIGS. 10a-e show different embodiments of pylon configurations to maximize its deswirling effects on the slipstream core airflow.

### DETAILED DESCRIPTION

Reference will now be made in detail to embodiments of the invention, examples of which are illustrated in the accompanying drawings intended to enable one skilled in the art to practice such embodiments. The accompanying drawings are not necessarily drawn to scale as they are provided for illustrative purposes and are not intended to limit the scope of the invention.

It will be understood that, the terms first, second, etc. are only used to distinguish one element from another. For example, a first attachment could be termed a second attachment, and, similarly, a second attachment could be termed a first attachment, without departing from the scope of the invention.

It will be understood that when an element or layer is referred to as being “on,” “coupled to,” or “connected to” another element or layer, it can be directly on, directly coupled to or directly connected to the other element or layer, or intervening elements or layers may be present. In contrast, when an element is referred to as being “directly on,” “directly coupled to,” or “directly connected to” another element or layer, there are no intervening elements or layers present.

As used in the description and the appended claims, the singular forms “a,” “an,” and “the” are intended to include the plural forms as well, unless the context clearly indicates otherwise. It will also be understood that the term “and/or” as used herein refers to and encompasses all possible combinations of one or more of the associated listed items.

As used herein, the term “motor” refers any mechanism used for generating mechanical power, including, but not limited to, electric motors, internal combustion engines, and gas turbine engines.

As used herein, the term “propeller” refers to any rotary device used for generating thrust, including, but not limited to, conventional propellers, rotors (including helicopter rotors), and proprotors.

As used herein, the term “pylon” refers to load-bearing body rigidly affixed to a propulsion assembly to support an auxiliary wing and is designed to transmit aerodynamic and inertial loads from the auxiliary wing to the propulsion assembly structure. Its design may impart deswirling to the spiraling slipstream core.

As used herein, the term “motor nacelle” refers to a streamlined housing or casing that surrounds an aircraft's engine, serving to reduce drag, protect the engine from debris, manage noise, provide access for maintenance, and house components like thrust reversers for braking during landing. It's the aerodynamic shell holding the engine and its vital systems.

“As used herein, the term ”propulsion assembly“ refers to the collective hardware and structural components configured to generate and direct propulsive thrust. This includes, but is not limited to, a power source (such as an electric motor, internal combustion engine, or turbine), a thrust-generating unit (such as a propeller, rotor, or fan), and any associated structural housing, motor nacelle, or mounting framework. The term further encompasses both open-rotor configurations and ducted or shrouded propulsion systems, regardless of whether the assembly is fixed, tilting, or otherwise articulable relative to the primary airframe.”

As used herein, the term “slipstream core” refers to the high-velocity spiraling airflow column directly behind the propeller. It is the most concentrated and forceful part of the propeller airflow and contains significant kinetic energy generally used as the thrust component of the aircraft's movement. It is much faster than the freestream air around the body of the aircraft. It has a component of swirl imparted by the spinning propeller. The slipstream core is the central, highest-energy region of the propeller slipstream.

As used herein, the term “STOL” refers to a class of aircraft possessing short take-off and landing capabilities. Certain STOL aircraft take off on short runways but land vertically.

As used herein, the term “VTOL” refers to a class of aircraft possessing vertical take-off and landing capabilities. VTOL aircraft can take off and land without needing a runway.

As used herein, the term “thrust” refers to the mechanical force produced by accelerating a large mass of air backward, (either by a spinning propeller or turbine blades) which, through Newton's third law of motion, pushes the aircraft forward. Its primary purpose is to overcome the force of drag (air resistance) and maintain forward motion or accelerate the aircraft.

As used herein, the term “airfoil” refers to a streamlined shape of an airplane wing that manipulates airflow to generate lift, when moving through air. Its curved upper surface and flatter bottom surface create a pressure difference, causing lower pressure above and higher pressure below, resulting in an upward lift force that allows aircraft to fly.

As used herein, the term “control surfaces” refers to movable parts on aircraft wings and tails (ailerons, elevators, rudder, flaps, slats, spoilers) that deflect airflow to change an aircraft's attitude and direction.

As used herein, the term “deswirl” refers to the aerodynamic process of redirecting, collimating, or otherwise modifying the rotational (tangential) component of a slipstream airflow into a more linear, axial direction. This process effectively recovers kinetic energy that would otherwise be lost to turbulence or rotational waste, converting it into useful forward thrust or reduced drag. Deswirling may be achieved through stationary or adjustable aerodynamic surfaces, such as pylons (of varying geometric configurations), vanes, or auxiliary wings, which intercept the spiraling flow to realign the air pressure vectors with the longitudinal axis of the aircraft.

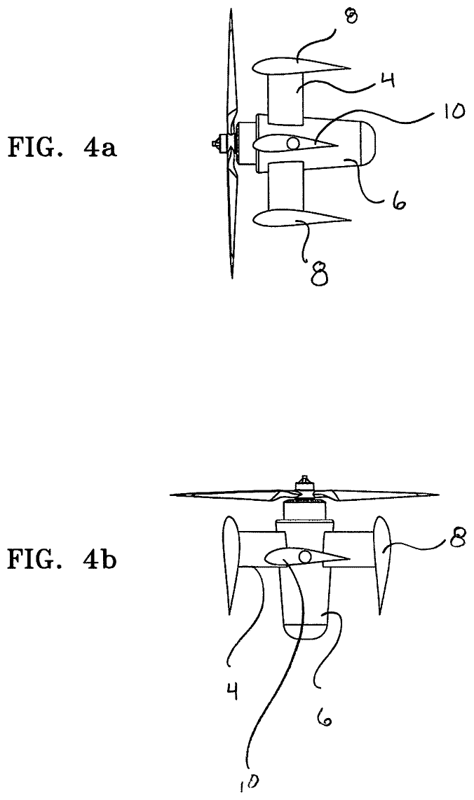

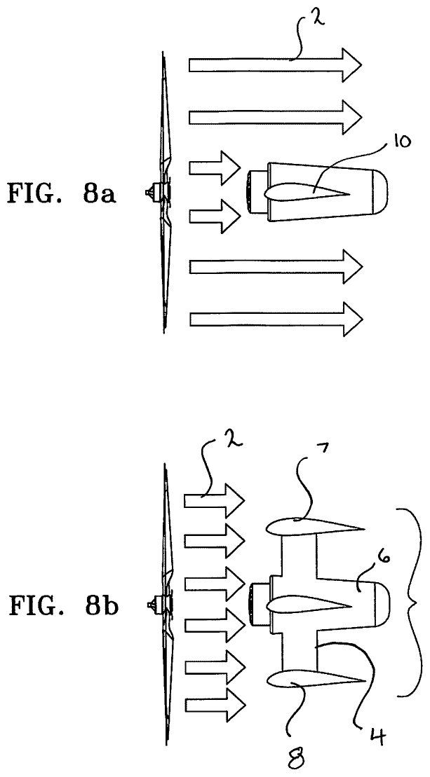

The present invention relates to a novel design that sets forth to maximize the lost energy in the large volume of slipstream core 2 (FIGS. 8a and 8b) that the propeller 12 (rotor or turbine blades) pushes backwards to develop both thrust for forward propulsion and lift from the air flowing over the fixed wing. It accomplishes this with two elements, at least one auxiliary wing 8 vertically higher or lower than the fixed-wing 10 for each propeller on the aircraft, and with the placement of pylons 4 between the propulsion assembly 6 and the auxiliary wing 8 in the slipstream core. (FIGS. 4a-b) In a conventional airplane the wingspan places much of the fixed-wing outside of the slipstream core 2. Most, if not all the air that passes over the surfaces of the fixed-wing 10 is due to the horizontal component of movement of the airplane. This produces enough lift to add the vertical component of motion to the airplane. In comparison, because of the placement of the auxiliary wings 7 and 8 directly behind the propeller, these engage the much faster slipstream core 2 which acts to produce massive amounts of lift despite their shorter wingspan. This additional lift garnered from the untapped kinetic energy in the slipstream offers additional vertical lift and axial thrust which translates to increased cruise speed, faster climb rates, longer flight range, greater payload capacity, while consuming less onboard energy storage, including but not limited to chemical, electrical, or hybrid sources, for a given flight profile.

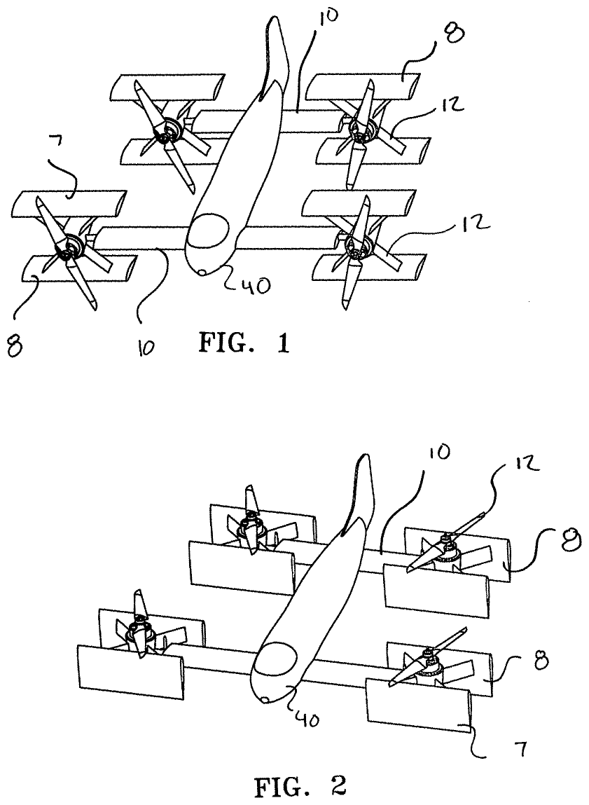

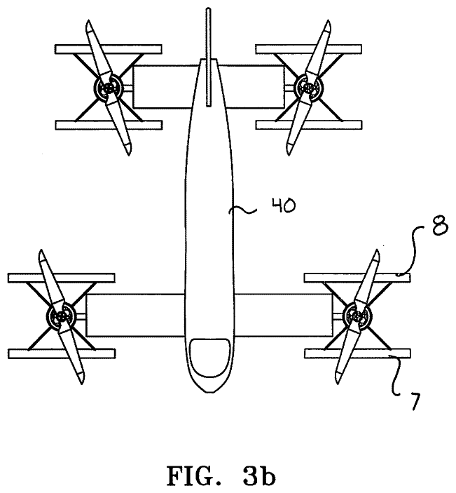

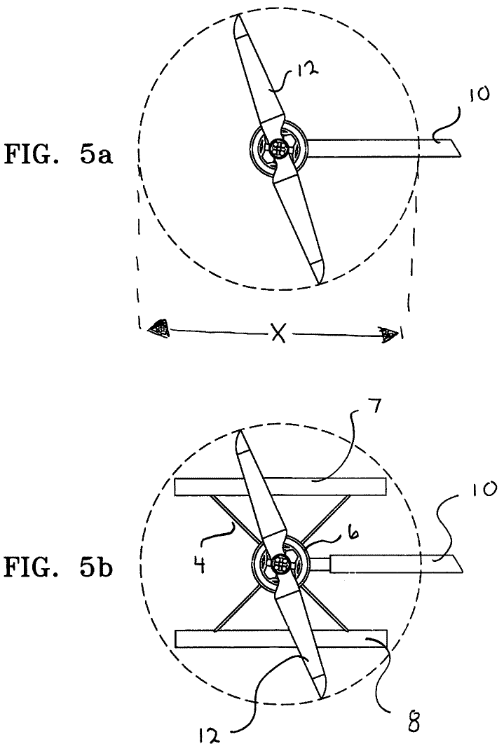

Looking at FIGS. 1-5 the apparatus is comprised of at least one auxiliary wing 7 or 8 (preferably both an upper 7 and lower auxiliary wing 8) that is placed behind yet in extremely close proximity to the propeller 12. This auxiliary wing 7 or 8 has a wingspan that approximates or is slightly longer than the diameter X of the slipstream core 2 (the spinning diameter of the propeller 12) such that it is fully or substantially overlapped by the slipstream core 2. (See FIG. 5b) The auxiliary wings wingspan and the height of the pylons 4 are dimensioned so that the wingspan is located within diameter of the slipstream core 2 generated by the spinning propeller, so that it is fully or substantially overlapped by the slipstream core. The upper auxiliary wing 7 and lower auxiliary wing 8 are placed above and below the centerline of the slipstream or the midpoint of the propeller arc.

This auxiliary wing 7 or 8 possesses an airfoil configuration like the fixed wing such that air rushing by it imparts lift. Essentially the supplemental lift that these auxiliary wings 7 and 8 provides is “free” as it is just reclaiming unused kinetic energy in the slipstream core 2 as only about one third of the slipstream core 2 rushing past the fixed-wing 10 affects the fixed-wing's lift in aircraft that places the propeller in front of the fixed-wing 10. In alternate embodiments, the auxiliary wings 7 and 8 may be angularly adjustable to alter the drag, swirl and turbulence of the air passing by it.

To ensure the auxiliary wings 7 and 8 receive the maximum benefit from the slipstream core 2, their leading edges are placed directly behind the propeller 12 (or turbine blades—not illustrated) that are generating the slipstream. The closer the auxiliary wings 7 and 8 are to the source of the slipstream, the more of the slipstream that can interface with the auxiliary wing 7 and 8. This is accomplished by mounting the auxiliary wings 7 and 8 to one end of at least one rigid structural pylon 4 and the other end of the pylon 4 to the propulsion assembly 6. This pylon 4 is designed to withstand the aerodynamic loading of the auxiliary wings 7 and 8 under all flight conditions. The auxiliary wings 7 and 8 thus reside directly in the slipstream core path, where they can garner the most lift. Since airplane motors and propellers generate their maximum thrust and airstream speed upon takeoff, this is the time the auxiliary wings 7 and 8 will have their greatest lift and is the time the aircraft has its greatest need for lift. This is especially true for STOL aircraft on takeoff and for VTOL aircraft when transitioning from vertical to horizontal flight. Since airplane engines and their propulsion assemblies are mounted to the fixed-wings 10 the lift created by the auxiliary wing 7 and 8 is transmitted through the pylons 4 to the propulsion assembly 6 to the fixed-wing 10 and thus the entire aircraft.

FIGS. 8 and 8 b show the effect on the slipstream core 2 with and without the auxiliary wings. In FIG. 8 a substantial portion, in certain embodiments as much as two thirds of the slipstream core 2, passes above or below the fixed-wing 10 without any effect on its top or bottom surfaces, hence not affecting lift. FIG. 8 b shows the addition of auxiliary wings 7 and 8 which are in the upper and lower regions of the slipstream core 2. Here, in this example, the upper and lower one third of the slipstream core acts on the aerodynamic surfaces of the upper 7 and lower auxiliary wings 8 to develop lift which is transmitted through the pylons 4 motor assemblies 6 and fixed-wing 10 to the aircraft. Prior to the insertion of the two auxiliary wings into the slipstream core 2, the upper and lower portions of the slipstream were not utilized. Hence the term “free” lift.

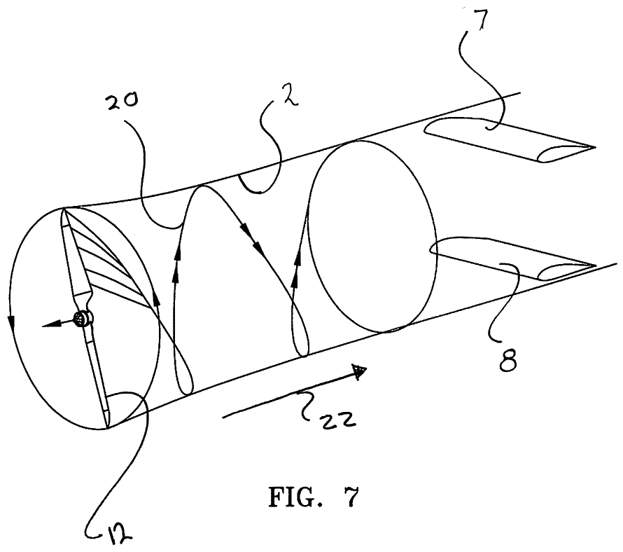

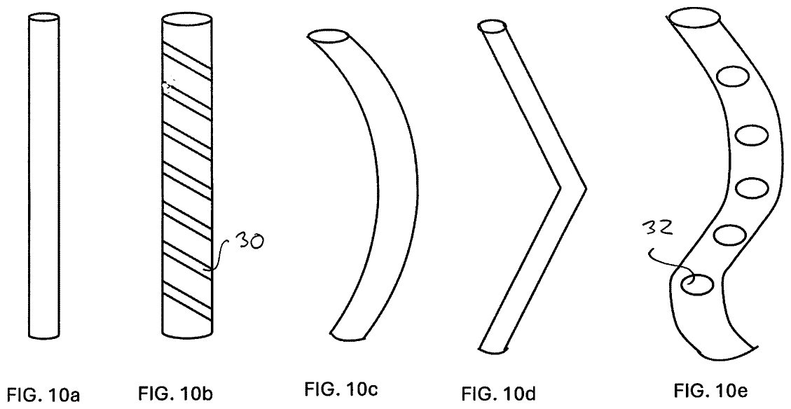

The tunnel of slipstream air (the core 2) has a swirl 20 imparted to it from the propeller 12. (FIG. 7) This means that the air is traveling in a non-linear fashion in an expanding cylindrical geometrical configuration towards the rear of the aircraft. If the swirling is reduced the thrust force vector 22 will increase as the individual air particle thrust vectors will collimate to a higher degree. This relates to an increase in vertical speed for the aircraft. Since the pylons 4 also reside in the slipstream core 2 they act to interrupt the swirl somewhat to deswirl the slipstream core 2 to increase the thrust. This is enhanced by the number of pylons 4 used to connect the auxiliary wings 7 and 8 to the propulsion assembly 6, the placement of the pylons 4 in the slipstream core 2 and the shape of the pylons 4. FIG. 10 a-e shows five alternate configurations for pylons 4, including straight, straight with deswirling spirals grooves 30, curved, angled, and serpentine with through orifices 32. Other designs not illustrated include fixed or moveable vanes, extensions perpendicular to the pylon 4 and the like. Determination of the design includes analysis of the increased drag vs the increase in thrust vs the loss in lift. This varies with the specifics of the aircraft design. The preferred embodiment utilizes a minimum of four pylons 4 per auxiliary wing 7 and 8 arranged in an X configuration.

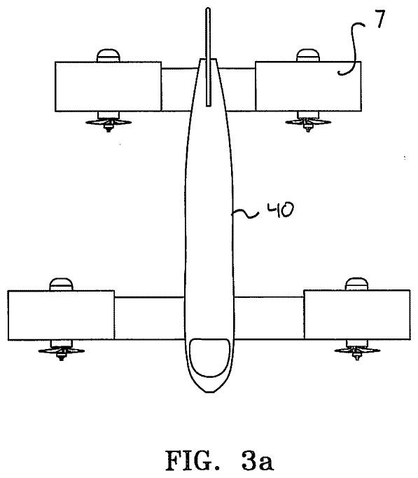

As another feature of this design, when used in a VTOL aircraft 40, the auxiliary wings 7 and 8 act as additional air brakes when slowing down to transition from horizontal flight to vertical flight for landing as seen in FIG. 2 b and 3 b. The auxiliary wings 7 and 8 also add additional lift as the propulsion assemblies rotate when the aircraft transitions from vertical flight to horizontal flight on take-off. This is a crucial point in the take off and this additional lift allows the transition to vertical flight as the motor and propeller tilt to occur quicker and at a lower elevation. Finally, the increase in thrust allows a quicker vertical take-off.

The method of utilizing the high lift apparatus to increase lift and thrust efficiency of a propeller-driven aircraft, comprises the following steps:
generating a spiraling slipstream core using a propeller mounted to a propulsion assembly;
positioning at least one auxiliary wing aft of the propeller and within the slipstream core;
extracting lift from portions of the slipstream core that do not substantially interact with a fixed wing of the aircraft, and
transmitting aerodynamic loads from the auxiliary wing to the aircraft through at least one pylon coupled to the propulsion assembly.

A distributed propulsion aircraft (having multiple motors) may increase its efficiency utilizing the following steps:
rotating a plurality of propellers to generate a plurality of slipstream cores;
intersecting each of said slipstream cores with at least one auxiliary wing;
converting the kinetic energy of said slipstream cores into distributed supplemental lift; and
transferring said lift to a plurality of motor-support structures to reduce the wing-loading requirement of the aircraft's fixed-wing.

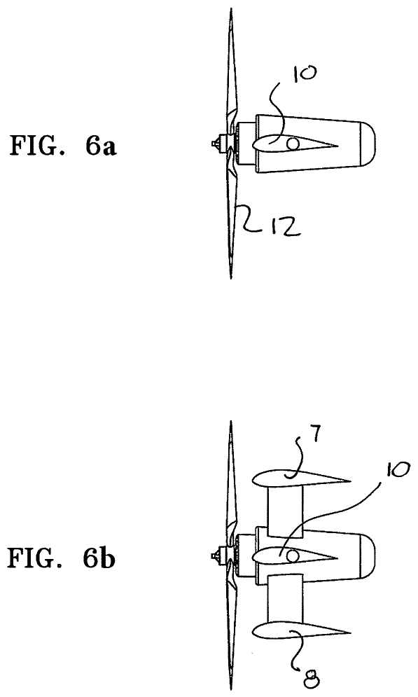

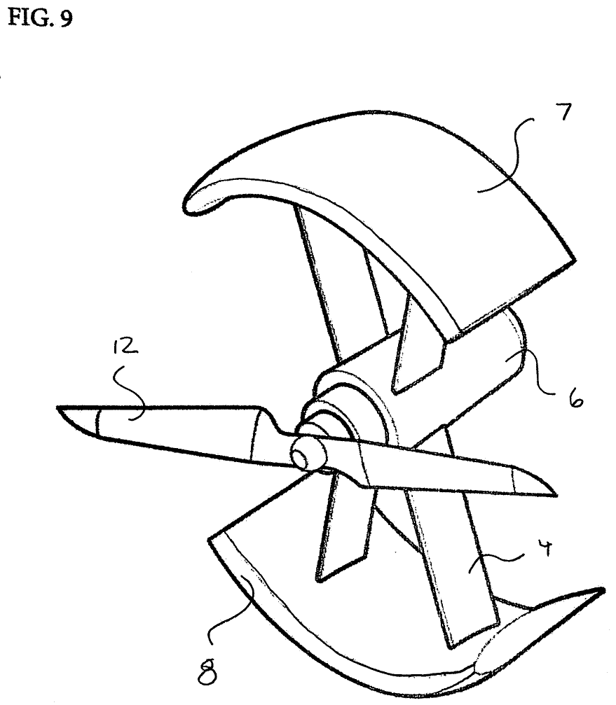

It is to be noted that the present invention may be utilized regardless of where the fixed wing is in relation to the motor and whether the aircraft's thrust and slipstream cores is generated from a propeller or a turbine. Essentially, it is airframe neutral and can be utilized with most aircraft. As such, multi engine aircraft with numerous elongated motor nacelles, typically referred to as “booms”, connected to the fixed wing will also benefit from this design wherein the auxiliary wings are located aft of and adjacent to the propellers and within the slipstream cores. It has application to a plethora of different aircraft however, its benefits are particularly applicable to VTOL, STOL and electric aircraft. For electric aircraft it offers reduced energy requirements with its reclaimed or “free” supplemental lift and thrust. For VTOL it offers a quicker transition to horizontal flight from vertical flight on take-off and offer the advantage of additional air brakes upon the transition from horizontal flight to vertical flight on landing. For STOL aircraft it offers additional lift for quicker take offs that can be accomplished on shorter runways. It is anticipated that the design of the auxiliary wings (whether a lower and upper auxiliary wing or just one is used per fixed wing) may have numerous physical configurations besides the ones shown in the conventional shaped airfoil wing of FIG. 6d/8b or arced airfoil wing of FIG. 9 and may encompass control surfaces to affect other effects. Similarly, the pylon 4 will generally have a very aerodynamic, smooth exterior configuration of a tubular linear member (FIG. 5b), however it may have additional exterior features such as swirls, bends, orifices, or arced surfaces to deswirl a portion of the slipstream core after the propeller or turbine blades (FIG. 10 a-e). The combination of the two inventive features have a synergistic combined effect of increased efficiency.

The invention has the following benefits that can augment the state of the art aircraft: reduced energy consumption, increased payload capacity, increased vertical thrust vector, extended electric range, reduced battery size and weight, smaller fixed-wings (reducing weight and drag, and enabling less energy required for propulsion), enhanced maneuverability including steeper climb rates, tighter turns, improved low-speed handling, delayed stall as higher airspeed over the wing can delay stall, allowing for steeper flight angles and improved maneuverability, and increased safety because of the additional lift for a given airspeed can maintain flight or gliding capability should a motor malfunction.

While certain features and aspects have been described with respect to exemplary embodiments, one skilled in the art will recognize that numerous modifications are possible. System components described according to a particular structural architecture may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added, and/or subtracted from among other described embodiments, unless the context dictates otherwise. Consequently, although several exemplary embodiments are described above, it will be appreciated that the invention is intended to cover all modifications and equivalents within the scope of the following claims.

1. An aircraft high-lift apparatus for use with a propeller-driven aircraft having a motor, a propulsion assembly, and a propeller that generates a spiralling slipstream core, the apparatus comprising:
at least one auxiliary wing positioned aft of the propeller and within said slipstream core; and
at least one pylon positioned at least partially within said slipstream core and mounting the auxiliary wing to a structural member of the propulsion assembly,
wherein the auxiliary wing is configured to generate lift from kinetic energy of the slipstream core that bypasses a fixed wing of the aircraft; and
a propeller slipstream core, and
wherein the pylon is configured to transmit aerodynamic loads from the auxiliary wing to the propulsion assembly and to reduce swirl in the slipstream core.

2. An aircraft high-lift apparatus for use with a propeller-driven aircraft having a motor, a propulsion assembly, and a propeller that generates a spiraling slipstream core, the apparatus comprising:
at least one auxiliary wing positioned aft of the propeller and within the slipstream core;
at least one pylon mounting the auxiliary wing to a propulsion assembly on the fixed-wing;
wherein the auxiliary wing is configured to generate lift from the kinetic energy of the slipstream core independent of the lift generated by the fixed-wing; and
wherein the pylon is positioned within the slipstream core and configured to transmit aerodynamic loads from the auxiliary wing to the propulsion assembly.

3. The apparatus of claim 1, wherein the auxiliary wing has a wingspan approximately equal to or less than a diameter of the slipstream core.

4. The apparatus of claim 1, wherein the auxiliary wing comprises an airfoil having a leading edge positioned aft of and adjacent to the propeller.

5. The apparatus of claim 1, further comprising an upper auxiliary wing positioned above a centerline of the slipstream core and a lower auxiliary wing positioned below the centerline.

6. The apparatus of claim 4, wherein the upper auxiliary wing and the lower auxiliary wing are each mounted to the propulsion assembly by at least one pylon.

7. The apparatus of claim 1, wherein the pylon has an exterior geometry configured to reduce swirl in the slipstream core.

8. The apparatus of claim 7, wherein the exterior geometry comprises a configuration selected from the group consisting of a straight profile, a curved profile, an angled profile, a serpentine profile, a spiraled profile, a grooved profile, a profile with moveable vanes or a profile with through-orifices to impart de-swirling to the slipstream core.

9. The apparatus of claim 1, wherein the auxiliary wing is rigidly fixed or angularly adjustable relative to the slipstream core to selectively alter lift or drag.

10. The apparatus of claim 1 wherein the auxiliary wing provides supplemental lift during transition from vertical flight to horizontal flight.

11. The apparatus of claim 1, wherein the auxiliary wing has an arced airfoil profile.

12. The apparatus of claim 1, wherein the motor is an electric motor.

13. The apparatus of claim 1, wherein the propulsion assembly includes a longitudinal boom, and the pylon is mounted thereto.

14. A method of increasing lift and thrust efficiency of a propeller-driven aircraft, comprising the steps of:
generating at least one spiraling slipstream core using at least one propeller mounted to at least one motor nacelle;
positioning at least one auxiliary wing aft of the at least one propeller and within the at least one slipstream core;
extracting lift from portions of the at least one slipstream core that do not substantially interact with a fixed wing of the aircraft; and
transmitting lift from the at least one auxiliary wing to the aircraft through at least one pylon coupled to the at least one motor nacelle.

15. The method of claim 14, further comprising reducing swirl in the slipstream core using said pylons to increases a forward thrust component of the slipstream core.

16. The method of claim 14, further comprising positioning an upper auxiliary wing above a centerline of the slipstream core and a lower auxiliary wing below the centerline.

17. The method of claim 14 further increasing the efficiency of a distributed propulsion aircraft, wherein each of at least one slipstream core is intersected by said at least one auxiliary wing so as to convert the kinetic energy of said slipstream cores into a distributed supplemental lift, transferring said lift to a plurality of propulsion assemblies to reduce the wing-loading requirement of the fixed wing.

18. The method of claim 14, wherein the method is performed during a takeoff phase to reduce required takeoff distance.

19. The method of claim 14, wherein the method is performed during a transition between vertical flight and horizontal flight in a VTOL aircraft.

20. The method of claim 14, further comprising using the auxiliary wing as an air brake during transition from horizontal flight to vertical flight.
